(19) United States
(12) Patent Application Publication
(10) Pub. No.: US 2009/0315336 A1
(43) Pub. Date: Dec. 24, 2009

(54) Renewable energy generation system

(76) Inventor: Hudson Worthington Harr, St. Petersburg, FL (US)

Correspondence Address: MICHAEL J. COLITZ, JR., 640 Douglas Avenue, DUNEDIN, FL, 34698, US

(21) Appl. No.: 12/214,843

(22) Filed: Jun. 23, 2008

(51) Int. Cl. H02K 7/18

(52) U.S. Cl. 290/1 R

(57) ABSTRACT

A plurality of exercise machines each have a generator with a rotating element for creating a current flow. A primary electrical cable is between the input and output ends. A plurality of feed lines couple an associated generator with the primary electrical cable. A diode is in each of the feed lines. Current is allowed to flow from the generators to the primary feed line and any back flow is precluded. A regulator coupled to each feed line is adapted to regulate the voltage of each machine and to maintain such voltage at a constant level. An inverter is coupled to the primary electrical cable. A combiner/controller along the primary electrical cable between the inverter and the feed lines is adapted to combine the current from the generators being fed to the inverter.

### BACKGROUND OF THE INVENTION

1. Field of the Invention

The present invention relates to a renewable energy generation system and more particularly pertains to capturing energy generated through the use of exercise machines for converting such captured energy into electrical power to be used in driving associated machinery, such captured energy also adapted to be returned to a communal power source, all in a safe, ecologically friendly, power conserving, grid-tied, and economical manner.

2. Description of the Prior Art

The use of renewable energy generation systems of known designs and configurations is known in the prior art. More specifically, renewable energy generation systems of known designs and configurations previously devised and utilized for the purpose of generating power through known methods and apparatuses are known to consist basically of familiar, expected, and obvious structural configurations, notwithstanding the myriad of designs encompassed by the crowded prior art which has been developed for the fulfillment of countless objectives and requirements.

By way of example, U.S. Patent Application Publication Number US 2002/0147079 published Oct. 10, 2002 to Kalnbach relates to a Human Generated Power Source.

While this device fulfills its particular objectives and requirements, the aforementioned patent does not describe a renewable energy generation system that allows for capturing energy generated through the use of exercise machines for converting such captured energy into electrical power to be used in driving associated machinery, such captured energy also adapted to be returned to a communal power source, all in a safe, eclogically friendly, power conserving, grid-tied, and economical manner.

In this respect, the renewable energy generation system according to the present invention substantially departs from the conventional concepts and designs of the prior art, and in doing so provides an apparatus primarily developed for the purpose of capturing energy generated through the use of exercise machines for converting such captured energy into electrical power to be used in driving associated machinery, such captured energy also adapted to be returned to a communal power source, all in a safe, eclogically friendly, power conserving, grid-tied, and economical manner.

Therefore, it can be appreciated that there exists a continuing need for a new and improved renewable energy generation system which can be used for capturing energy generated through the use of exercise machines for converting such captured energy into electrical power to be used in driving associated machinery, such captured energy also adapted to be returned to a communal power source, all in a safe, eclogically friendly, power conserving, grid-tied, and economical manner. In this regard, the present invention substantially fulfills this need.

### SUMMARY OF THE INVENTION

In view of the foregoing disadvantages inherent in the known types of renewable energy generation systems of known designs and configurations now present in the prior art, the present invention provides an improved renewable energy generation system. As such, the general purpose of the present invention, which will be described subsequently in greater detail, is to provide a new and improved renewable energy generation system and method which has all the advantages of the prior art and none of the disadvantages.

To attain this, the present invention essentially comprises a renewable energy generation system. First provided is a plurality of exercise machines. The exercise machines are chosen from the class of exercise machines. The class of exercise machines includes elliptical machines, climbers, treadmills, bikes and like machines. Each exercise machine has a generator. The generator has a rotating element. Each rotating element is adapted to be rotated through the exercising activities of a user. In this manner a current flow is created.

A primary electrical cable is provided. The primary electrical cable has an input end. The primary electrical cable has an output end. The primary electrical cable has an intermediate extent. The intermediate extent is provided between the input and output end.

Provided next is a plurality of feed lines. Each feed line couples an associated generator. Spaced regions are provided on the intermediate extent of the primary electrical cable. A diode is provided in each feed line. The diode allows current flow from the generators to the primary feed line. The diode further precludes any back flow of current from the primary feed line to the generators.

A regulator is provided next. The regulator is coupled to each feed line. The regulator is adapted to regulate upwardly and downwardly the voltage of each machine. The regulator is further adapted to maintain such voltage at a constant level, regardless of the input work from the user at a machine. In the preferred embodiment, the constant level is 50 volts. The regulator is also adapted to allow the current contribution of each machine to vary as a function of the input work from the user at a machine.

An inverter is provided. The inverter has an input end. The inverter has an output end. The input end of the inverter is coupled to the output end of the primary electrical cable. A transformer is provided. The transformer couples the inverter to a 120 volt AC source of potential. In this manner the inverter is powered.

Next provided is a combiner/controller. The combiner/controller is provided along the primary electrical cable between the inverter and the feed lines. The combiner/controller is adapted to combine the current from the generators being fed to the inverter.

A main circuit breaker panel is provided next. The main circuit breaker panel has a first end. The main circuit breaker panel has a second end. The first end of the main breaker panel is coupled to a source of potential of a facility housing the system. The second end of the main breaker panel is coupled to the output end of the inverter. The main circuit breaker panel is adapted to monitor current flow through a facility housing and power the transformer and the machines as well as other electrical powered devices. The main circuit breaker panel is also adapted to terminate current flow through such facility. In this manner power to the transformer and machines as well as other electrical powered devices is terminated in the event of a short circuit or overload. The transformer output in the preferred embodiment is 50 volts at 0.3 amps. In this manner the inverter stays online and synchronized to the grid with minimum loss.

Further provided is a secondary electrical cable. The secondary electrical cable has an input end. The secondary electrical cable has an output end. The secondary electrical cable has an intermediate extent. The intermediate extent is provided between the input and output end. The output end of the secondary electrical cable is coupled to the input end of the main breaker panel. The input end of the secondary cable is coupled to the output end of the inverter. An AC disconnect is provided. The AC disconnect is provided along the secondary electrical cable between the inverter and the main breaker panel. The AC disconnect is under the control and discretion of a user. The AC disconnect is adapted to terminate the flow of current from the main breaker panel to the inverter and combiner/controller and generators.

Provided last is a display screen. The display screen is provided on each exercise machine. The display screen is adapted to provide a visual display of a plurality of factors being generated by a each particular user of each particular exercise machine at any given time during a particular exercise program. Such factors include user-watts, voltage, peak amps and peak watts.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved renewable energy generation system which has all of the advantages of the prior art renewable energy generation systems of known designs and configurations and none of the disadvantages.

It is another object of the present invention to provide a new and improved renewable energy generation system which may be easily and efficiently manufactured and marketed.

It is further object of the present invention to provide a new and improved renewable energy generation system which is of durable and reliable constructions.

An even further object of the present invention is to provide a new and improved renewable energy generation system which is susceptible of a low cost of manufacture with regard to both materials and labor, and which accordingly is then susceptible of low prices of sale to the consuming public, thereby making such renewable energy generation system economically available to the buying public.

Even still another object of the present invention is to provide a renewable energy generation system for capturing energy generated through the use of exercise machines for converting such captured energy into electrical power to be used in driving associated machinery, such captured energy also adapted to be returned to a communal power source, all in a safe, ecologically friendly, power conserving, grid-tied, and economical manner.

Lastly, it is an object of the present invention to provide a new and improved renewable energy generation system. A plurality of exercise machines is provided. Each machine has a generator with a rotating element for creating a current flow. A primary electrical cable is provided between the input and output ends. A plurality of feed lines couple an associated generator with the primary electrical cable. A diode is provided in each of the feed lines. In this manner current is allowed to flow from the generators to the primary feed line but any back flow is precluded. A regulator is coupled to each feed line. The regulator is adapted to regulate the voltage of each machine and to maintain such voltage at a constant level. An inverter is coupled to the primary electrical cable. A combiner/controller is provided along the primary electrical cable between the inverter and the feed lines. The combiner/controller is adapted to combine the current from the generators being fed to the inverter.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective illustration of a first section of a power generating system constructed in accordance with the principles of the present invention.

FIG. 2 is a perspective illustration of a second section of a power generating system constructed in accordance with the principles of the present invention.

FIG. 3 is a plan view of a display screen of one of the exercise machines.

FIG. 4 is an electrical schematic illustration of the power generating system of the prior Figures.

The same reference numerals refer to the same parts throughout the various Figures.

### DESCRIPTION OF THE PREFERRED EMBODIMENT

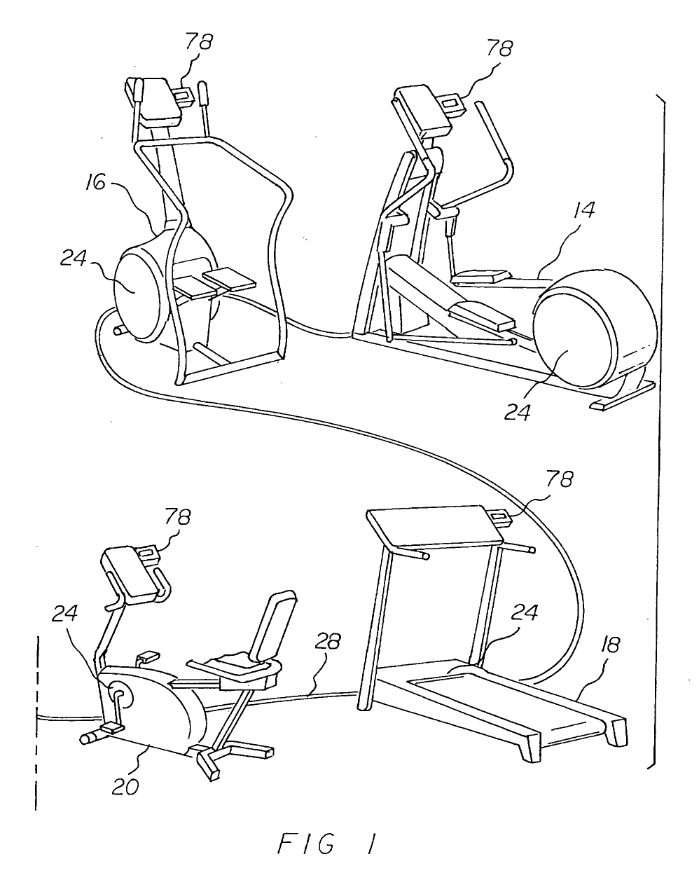

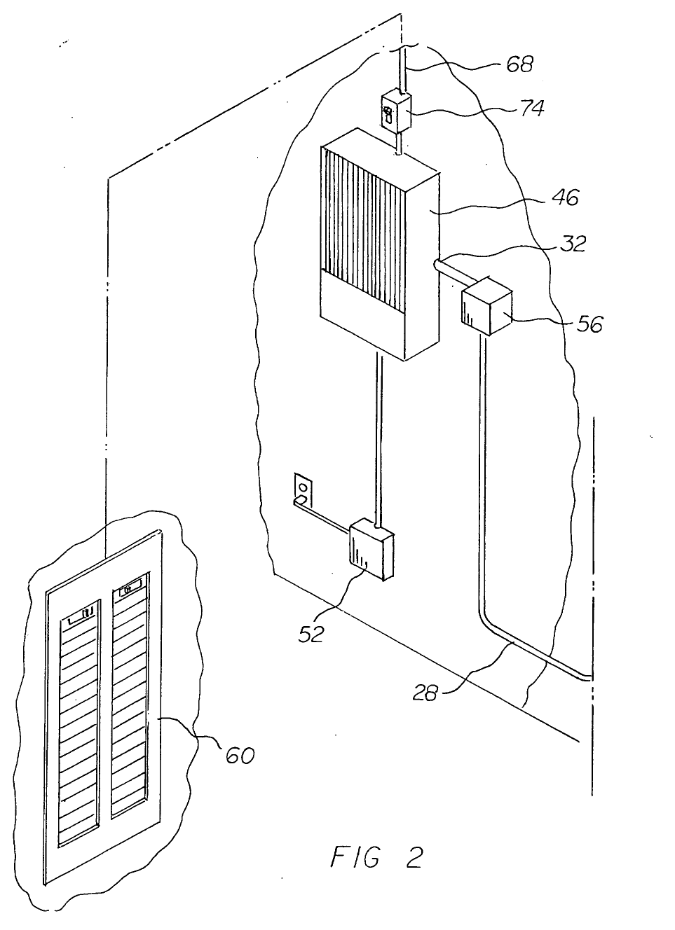

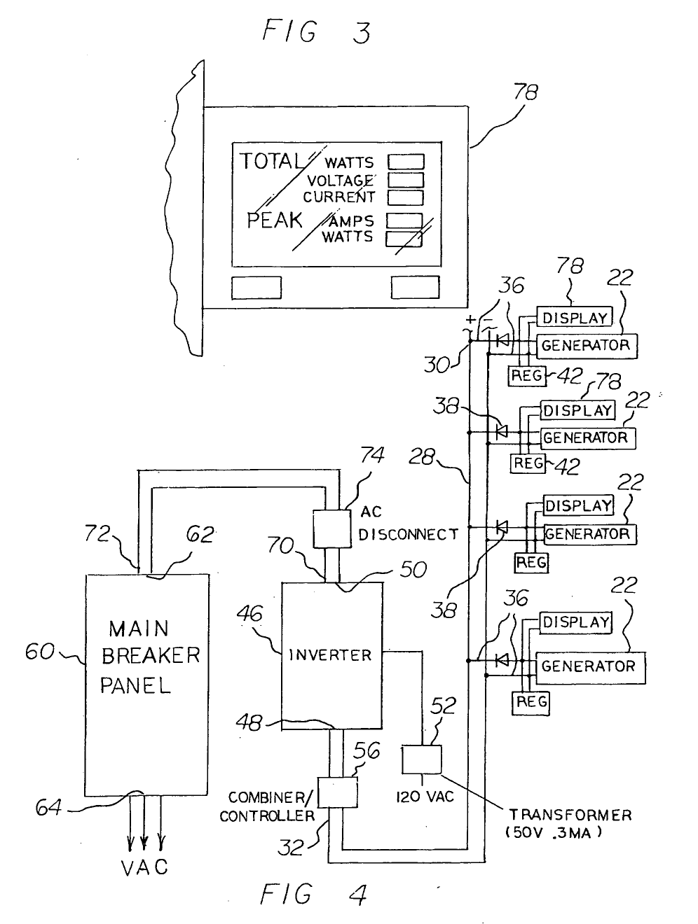

With reference now to the drawings, and in particular to FIG. 1 thereof, the preferred embodiment of the new and improved renewable energy generation system embodying the principles and concepts of the present invention and generally designated by the reference numeral 10 will be described.

The present invention, the renewable energy generation system 10 is comprised of a plurality of components. Such components in their broadest context include a plurality of exercise machines, a primary electrical cable, a plurality of feed lines, a regulator, an inverter and a combiner/controller. Such components are individually configured and correlated with respect to each other so as to attain the desired objective.

First provided is a plurality of exercise machines. The exercise machines are chosen from the class of exercise machines. The class of exercise machines includes elliptical machines 14, climbers 16, treadmills 18, bikes 20 and like machines. Each exercise machine has a generator 22. The generator has a rotating element 24. Each rotating element is adapted to be rotated through the exercising activities of a user. In this manner a current flow is created.

A primary electrical cable 28 is provided. The primary electrical cable has an input end 30. The primary electrical cable has an output end 32. The primary electrical cable has an intermediate extent. The intermediate extent is provided between the input and output end.

Provided next is a plurality of feed lines 36. Each feed line couples an associated generator. Spaced regions are provided on the intermediate extent of the primary electrical cable. A diode 38 is provided in each feed line. The diode allows current flow from the generators to the primary feed line. The diode further precludes any back flow of current from the primary feed line to the generators.

A regulator 42 is provided next. The regulator is coupled to each feed line. The regulator is adapted to regulate upwardly and downwardly the voltage of each machine. The regulator is further adapted to maintain such voltage at a constant level, regardless of the input work from the user at a machine. In the preferred embodiment, the constant level is 50 volts. The regulator is also adapted to allow the current contribution of each machine to vary as a function of the input work from the user at a machine.

An inverter 46 is provided. The inverter has an input end 48. The inverter has an output end 50. The input end of the inverter is coupled to the output end of the primary electrical cable. A transformer 52 is provided. The transformer couples the inverter to a 120 volt AC source of potential. In this manner the inverter is powered which keeps the unit online and grid synchronous.

Next provided is a combiner/controller 56. The combiner/controller is provided along the primary electrical cable between the inverter and the feed lines. The combiner/controller is adapted to combine the current from the generators being fed to the inverter.

A main circuit breaker panel 60 is provided next. The main circuit breaker panel has a first end 62. The main circuit breaker panel has a second end 64. The first end of the main breaker panel is coupled to a source of potential of a facility housing the system. The second end of the main breaker panel is coupled to the output end of the inverter via a standard wall plug. The main circuit breaker panel is adapted to monitor current flow through a facility housing and power the transformer and the machines as well as other electrical powered devices. The main circuit breaker panel is also adapted to terminate current flow through such facility. In this manner power to the transformer and machines as well as other electrical powered devices is terminated in the event of a short circuit or overload. The transformer output in the preferred embodiment is 50 volts at 0.3 amps. In this manner the inverter stays online and synchronized to the grid with minimum loss.

Further provided is a secondary electrical cable 68. The secondary electrical cable has an input end 70. The secondary electrical cable has an output end 72. The secondary electrical cable has an intermediate extent. The intermediate extent is provided between the input and output ends. The output end of the secondary electrical cable is coupled to the input end of the main breaker panel. The input end of the secondary cable is coupled to the output end of the inverter. An AC disconnect 74 is provided. The AC disconnect is provided along the secondary electrical cable between the inverter and the main breaker panel. The AC disconnect is under the control and discretion of a user. The AC disconnect is adapted to terminate the flow of current from the main breaker panel to the inverter and combiner/controller and generators.

Provided last is a display screen 78. The display screen is provided on each exercise machine. The display screen is adapted to provide a visual display of a plurality of factors being generated by a each particular user of each particular exercise machine at any given time during a particular exercise program. Such factors include user-watts, voltage, peak amps and peak watts.

The inverter's 120 volt wall plug-in power may be thought of in an auxiliary fashion serving only as backup to maintain the connection and circumvent the inverter's startup process so that array is live instantaneously when users get on the machines. Considering that the machine's load is dependent upon the inverter's dynamic loading, there must always be a “grid” connection for the users to experience resistance.

The secondary cable is only pertinent due to the amount of current flow which could reach 20 plus amps coming from the array. This requires a dedicated line to the system.

The system negates the need for batteries, in the preferred embodiment, and utilizes the building's load as resistance to the users. It uses this dynamic load to optimize each machine creating an identical user experience to the machine's previous state. The load to exercise equipment is optimized so users cannot discern which machines are hooked into the system and which are factory default stand alone units.

By using the building as the load directly, work is being performed to offset the power coming into the facility via the utility grid on a continual basis. This allows power to be sent to the building for immediate use while minimizing losses.

The user experience does not vary from day to day and is independent of the number of machines in use.

The system allows users to make current contributions to the building/grid without feedback between machines. Each unit operates on the same parallel circuit but is not affected by neighboring machines. The load experienced by the user is a constant independent of other machines' utilization.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by LETTERS PATENT of the United States is as follows:

1. A renewable energy generation system comprising:
a plurality of exercise machines, each having a generator with a rotating element for creating a current flow;
a primary electrical cable between the input and output ends;
a plurality of feed lines coupling an associated generator with the primary electrical cable, a diode in each feed line to allow current flow from the generators to the primary feed line and to preclude any back flow;
a regulator coupled to each feed line adapted to regulate the voltage of each machine and to maintain such voltage at a constant level;
an inverter coupled to the primary electrical cable; and
a combiner/controller along the primary electrical cable between the inverter and the feed lines, the combiner/controller adapted to combine the current from the generators being fed to the inverter.

2. The system as set forth in claim 1 and further including:
a main circuit breaker panel coupled to a source of potential of a facility housing the system, the main circuit breaker panel adapted to monitor current flow through a facility housing and power the transformer and the machines as well as other electrical powered devices, the main circuit breaker panel also adapted to terminate current flow through such facility to terminate power to the transformer and machines as well as other electrical powered devices in the event of a short circuit or overload.

3. The system as set forth in claim 2 and further including:
a secondary electrical cable coupled to the main breaker panel, the output end of the secondary cable coupled to the input end of the inverter, an AC disconnect along the secondary electrical cable between the inverter and the main breaker panel, the AC disconnect under the control and discretion of a user and adapted to terminate the flow of current from the main breaker panel to the inverter and combiner/controller and generators.

4. The system as set forth in claim 1 and further including:
a display screen on each exercise machine adapted to provide a visual display of a plurality of factors being generated by a each particular user of each particular exercise machine at any given time during a particular exercise program.

5. A renewable energy generation system for capturing energy generated through the use of exercise machines and for converting such captured energy into electrical power to be used in driving associated machinery, such captured energy also adapted to be returned to a communal power source, all in a safe, ecologically friendly, power conserving, grid-tied, and economical manner, the system comprising, in combination:
a plurality of exercise machines chosen from the class of exercise machines including elliptical machines, climbers, treadmills, bikes and like machines, each exercise machine having a generator with a rotating element, each rotating element adapted to be rotated through the exercising activities of a user for creating a current flow;
a primary electrical cable having an input end and an output end with an intermediate extent between the input and output end;
a plurality of feed lines, each feed line coupling an associated generator with spaced regions on the intermediate extent of the primary electrical cable, a diode in each feed line to allow current flow from the generators to the primary feed line and to preclude any back flow of current from the primary feed line to the generators;
a regulator coupled to each feed line adapted to regulate upwardly and downwardly the voltage of each machine and to maintain such voltage at a constant level, 50 volts in the preferred embodiment, regardless of the input work from the user at a machine, the regulator also adapted to allow the current contribution of each machine to vary as a function of the input work from the user at a machine;
an inverter having an input end and an output end, the input end of the inverter coupled to the output end of the primary electrical cable, a transformer coupling the inverter to a 120 volt AC source of potential for powering the inverter;
a combiner/controller along the primary electrical cable between the inverter and the feed lines, the combiner/controller adapted to combine the current from the generators being fed to the inverter;
a main circuit breaker panel having a first end and a second end, the first end of the main breaker panel coupled to a source of potential of a facility housing the system, the second end of the main breaker panel coupled to the output end of the inverter, the main circuit breaker panel adapted to monitor current flow through a facility housing and power the transformer and the machines as well as other electrical powered devices, the main circuit breaker panel also adapted to terminate current flow through such facility to terminate power to the transformer and machines as well as other electrical powered devices in the event of a short circuit or overload, the transformer output in the preferred embodiment being 50 volts at 0.3 amps to insure that the inverter stays online and synchronized to the grid with minimum loss;
a secondary electrical cable having an input end and an output end with an intermediate extent between the input and output end, the output end of the secondary electrical cable coupled to the input end of the main breaker panel, the input end of the secondary cable coupled to the output end of the inverter, an AC disconnect along the secondary electrical cable between the inverter and the main breaker panel, the AC disconnect under the control and discretion of a user and adapted to terminate the flow of current from the main breaker panel to the inverter and combiner/controller and generators; and
a display screen on each exercise machine adapted to provide a visual display of a plurality of factors being generated by a each particular user of each particular exercise machine at any given time during a particular exercise program, such factors including user-watts, voltage, peak amps and peak watts.
